(19) United States
(12) Patent Application Publication
(10) Pub. No.: US 2021/0406013 A1
(43) Pub. Date: Dec. 30, 2021

(54) PROCESSING DEVICE, INFORMATION PROCESSING DEVICE, AND INFORMATION PROCESSING METHOD

(71) Applicant: Preferred Networks, Inc., Tokyo (JP)

(72) Inventors: Daichi TERUYA, Tokyo (JP); Hiroya KANEKO, Tokyo (JP); Hirochika ASAI, Tokyo (JP)

(21) Appl. No.: 17/468,914

(22) Filed: Sep. 8, 2021

Related U.S. Application Data
(63) Continuation of application No. PCT/JP2020/009444, filed on Mar. 5, 2020.

(30) Foreign Application Priority Data
Mar. 12, 2019 (JP) 2019-044984

(51) Int. Cl. G06F 9/30; H04L 29/06

(52) U.S. Cl. CPC G06F 9/3016; H04L 69/22

(57) ABSTRACT

A processing device includes at least one memory, and at least one processor configured to receive a packet including a plurality of instructions, context information indicating an execution state of the plurality of instructions, and data to be processed by the plurality of instructions, execute at least a part of the plurality of instructions based on the context information, and transmit the packet to another processing device, after executing the at least the part of the plurality of instructions by the processing device, to cause at least a part of remaining instructions among the plurality of instructions to be executed, based on the context information, the remaining instructions being not executed by the processing device.

### CROSS-REFERENCE TO RELATED APPLICATIONS

This application is a continuation application of International Application No. PCT/JP2020/009444 filed on Mar. 5, 2020, and designating the U.S., which is based upon and claims priority to Japanese Patent Application No. 2019-044984, filed on Mar. 12, 2019, the entire contents of which are incorporated herein by reference.

### BACKGROUND

### 1. Technical Field

The disclosure herein relates to a processing device, a processing device, an information processing device, an information processing method, and a non-transitory computer-readable recording medium having stored therein a

### 2. Description of the Related Art

In-Network Computing, in which computation is performed during the transfer of packets in a network, has attracted attention. In In-Network Computing, for example, a network is controlled so that transferred packets are processed in the order requested by the packets on nodes (processing devices) having computing functions.

Additionally, a service chaining system, in which an identification device identifies a service function to be applied to a packet, assigns an identifier (NSH: Network Service Header) to the packet, and a transferring device transfers the packet to the service function or the like by referring to the identifier, is known.

In the service chaining system described above, for example, by writing the ID of a requested operation in the NSH header, the packet is transferred to a computing node that can execute the operation, and the operation is executed.

However, such a method presupposes that the computing node has a specific computing function in advance, and there is a problem that the method cannot be applied to a case in which a given program is executed on a network from a terminal, for example.

An embodiment of the present disclosure has been made in view of the above-described problem, and in an information processing system including multiple processing devices that execute predetermined processes during the transfer of packets in a network, a given program can be specified from a terminal to execute the process.

### SUMMARY

According to one aspect of the present disclosure, a processing device includes at least one memory, and at least one processor configured to receive a packet including a plurality of instructions, context information indicating an execution state of the plurality of instructions, and data to be processed by the plurality of instructions, execute at least a part of the plurality of instructions based on the context information, and transmit the packet to another processing device, after executing the at least the part of the plurality of instructions by the processing device, to cause at least a part of remaining instructions among the plurality of instructions to be executed, based on the context information, the remaining instructions being not executed by the processing device.

According to at least one embodiment of the present disclosure, in an information processing system including multiple processing devices that execute predetermined processes during the transfer of packets in a network, a given program can be specified from a terminal to execute the process.

### BRIEF DESCRIPTION OF THE DRAWINGS

FIG. 1 is a diagram illustrating an example of a system configuration of an information processing system according to an embodiment;

FIG. 2 is a diagram illustrating an example of a hardware configuration of a processing device according to the embodiment;

FIG. 3 is a diagram illustrating an example of a functional configuration of the processing device according to the embodiment;

FIG. 4A is a first diagram for explaining information included in a packet according to a first embodiment;

FIG. 4B is a second diagram for explaining the information included in the packet according to the first embodiment;

FIG. 5 is a flowchart illustrating an example of a process of a packet interpreting unit according to the first embodiment;

FIG. 6 is a flowchart illustrating an example of a process of an instruction execution control unit according to the first embodiment;

FIG. 7 is a diagram for explaining an example of an operation of an information processing system according to the first embodiment;

FIG. 8 is a diagram illustrating an example of a functional configuration of a processing device according to a second embodiment;

FIG. 9 is a diagram illustrating an example of a configuration of a packet according to the second embodiment;

FIG. 10 is a flowchart illustrating an example of a process of an instruction execution control unit according to the second embodiment;

FIG. 11 is a flowchart illustrating an example of a process of a memory access unit according to the second embodiment; and

FIG. 12 is a diagram for explaining an example of a processing system according to the second embodiment.

### DETAILED DESCRIPTION

In the following, the embodiments of the present disclosure will be described in detail with reference to the drawings.

### System Configuration

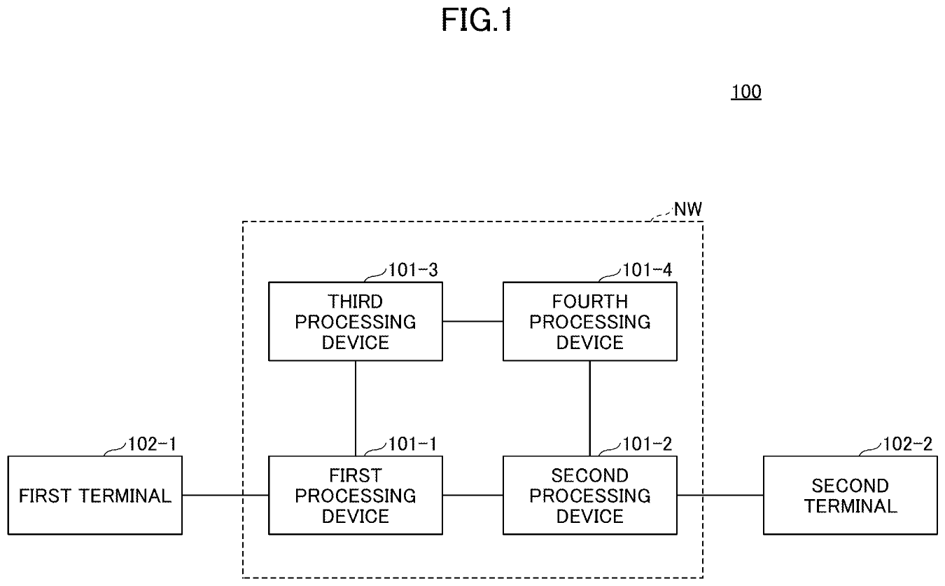

FIG. 1 is a diagram illustrating an example of a configuration of an information processing system according to an embodiment. The information processing system 100 may include multiple processing devices (a first processing device 101-1, a second processing device 101-2, a third processing device 101-3, and a fourth processing device 101-4) and multiple terminals (a first terminal 102-1, a second terminal 102-2) provided in a network NW. In the following description, among multiple processing devices (the first processing device 101-1, the second processing device 101-2, the third processing device 101-3, and the fourth processing device 101-4), when any one of the processing devices is indicated, a “processing device 101” is used. Additionally, among multiple terminals (the first terminal 102-1, the second terminal 102-2), when any one of the multiple terminals is indicated, a “terminal 102” is used.

The number of the processing devices 101 illustrated in FIG. 1 is an example, and the number of the processing devices 101 may be another number greater than or equal to two. The number of the terminals 102 illustrated in FIG. 1 is an example, and the number of the terminals 102 may be another number greater than or equal to one. Further, the topology of the network NW illustrated in FIG. 1 is an example, and a connection relationship between the processing devices 101 may be different from the connection relationship illustrated in FIG. 1.

Here, the following description assumes that a data transfer route within the network NW is determined by the respective processing devices 101, a routing device, or the like by a predetermined routing algorithm, and is stored in routing tables of the respective processing devices 101.

The processing device 101 may be a device or an information processing device having a configuration of a computer that performs a transfer process of a packet (i.e., an example of data) in the network NW and may execute an instruction stored in the packet. Here, as an example, the following description assumes that the processing device 101 is a switch that performs the transfer process of the packet in the network NW. However, the processing device may be a server device, an information terminal, or the like.

The terminal 102 may be an information processing device that transmits, to the processing device 101, a packet including multiple instructions to be processed in the network NW, context information indicating an execution state of the multiple instructions, and data to be processed by the multiple instructions. Specific examples of the terminal 102 include an information terminal such as a personal computer (PC), a smartphone, a tablet terminal, a device such as a robot or an automobile, and a server device. Additionally, the terminal 102 may have a function of processing data and also serve as the processing device 101, and may have a function of generating a packet without processing the data.

For example, in FIG. 1, the first terminal 102-1 transmits, to the second terminal 102-2 via the network NW, a packet including multiple instructions to be processed in the network NW, context information indicating an execution state of the multiple instructions, and data to be processed by the multiple instructions.

Consequently, the first processing device 101-1 receives the packet transmitted from the first terminal 102-1, and if the packet is not a packet to be processed by the first processing device 101-1, the first processing device 101-1 transfers the packet to another processing device (for example, the second processing device 101-2), which is a transfer destination.

With respect to the above, if the received packet is a packet to be processed by the first processing device 101-1, the first processing device 101-1 executes at least a part of the multiple instructions included in the packet based on the context information included in the packet. Additionally, if the first processing device executes at least the part of the instructions, the first processing device 101-1 transmits, for example, to the second processing device 101-2, the packet including context information indicating that at least the part of the instructions is executed and the data processed by executing at least the part of the instructions.

If the packet received from the first processing device 101-1 is a packet to be processed by the second processing device 101-2, the second processing device 101-2 executes at least a part of the multiple instructions included in the packet, as in the first processing device 101-1. If the second processing device 101-2 executes at least the part of the instructions, the second processing device 101-2 transmits, for example, to the second terminal 102-2, the packet including the context information indicating that at least the part of the instructions is executed and the data processed by executing at least the part of the instructions. For example, the second terminal 102-2 sequentially executes the instructions that have not been executed among the multiple instructions included in the packet based on the context information included in the received packet.

As described, in the information processing system 100 according to the present embodiment, by transmitting the packet from the first terminal 102-1 to the second terminal 102-2 via the network NW, part or all of the instructions included in the packet may be executed in the network NW.

### Hardware Configuration

### Hardware Configuration of the Processing Device

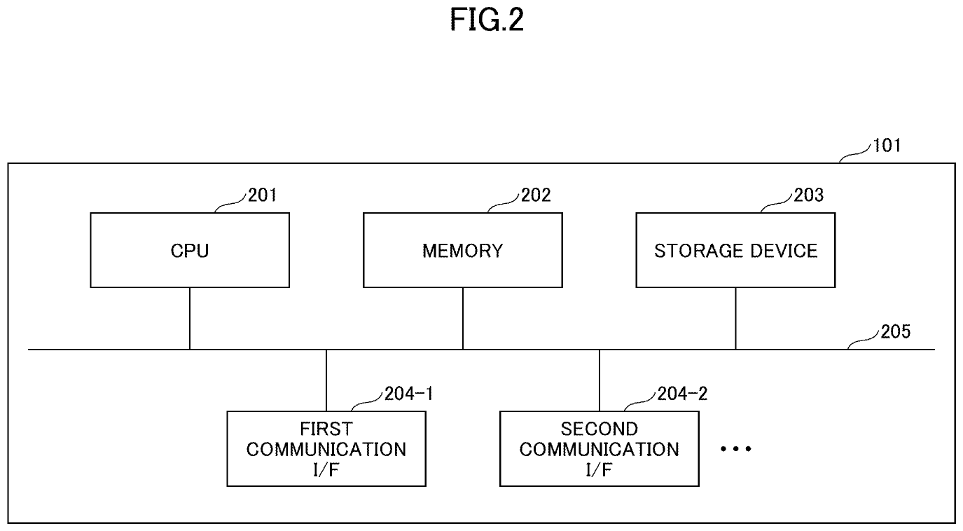

FIG. 2 illustrates an example of a hardware configuration of the processing device according to the embodiment. The processing device 101 includes, for example, a central processing unit (CPU) 201, a memory 202, a storage device, multiple communication interfaces (a first communication I/F 204-1, a second communication I/F 204-2, . . . ), and a bus 205. In the following description, when any one of the communication I/Fs is indicated among the first communication I/F 204-1 and the second communication I/F 204-2, . . . , the “communication I/F 204” is used.

The CPU 201 is, for example, an arithmetic device that implements a function of the processing device 101 by executing a program stored in the storage device 203, the memory 202, or the like. For example, the memory 202 includes a random access memory (RAM), which is a volatile memory used as a work area of the CPU 201, a read only memory (ROM), which is a non-volatile memory in which a program for starting the processing device 101 is stored, and the like. The storage device 203 is, for example, a large capacity storage device such as a solid state drive (SSD) or a flash ROM that stores an operating system (OS), an application, data, and the like.

The multiple communication I/Fs 204 include, for example, a network interface card (NIC), a communication module, or the like that performs a local area network (LAN) communication or a wide area network (WAN) communication with another processing device 101, the terminal 102, and the like.

Here, the hardware configuration of the processing device 101 illustrated in FIG. 2 is an example. The processing device 101 may further include various hardware components, such as a display device, an input device, or the like. Additionally, if the processing device 101 is a switch (i.e., a network switch), the processing device 101 may further include an application specific integrated circuit (ASIC) or the like that performs the packet transfer process in hardware.

### First Embodiment

Next, a functional configuration of a processing device 101 according to a first embodiment will be described.

### Functional Configuration

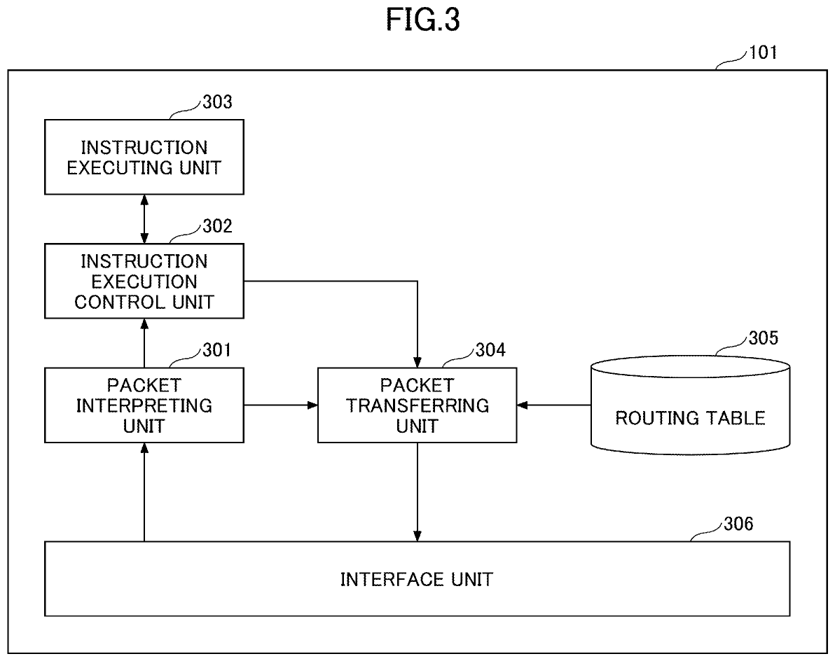

FIG. 3 is a diagram illustrating an example of a functional configuration of the processing device according to the first embodiment. The processing device 101 includes, for example, a packet interpreting unit 301, an instruction execution control unit 302, an instruction executing unit 303, a packet transferring unit (i.e., an example of a transferring unit) 304, a routing table 305, an interface unit 306, and the like.

The packet interpreting unit 301 is implemented by, for example, a program executed by the CPU 201 of FIG. 2 or an ASIC or the like that performs the above-described packet transferring process. The packet interpreting unit 301 may determine whether the packet received by the interface unit 306 is a packet to be processed by the processing device 101 and may transmit the packet to be processed by the processing device 101 to the instruction execution control unit 302. The packet interpreting unit 301 is an example of a receiving unit that receives a packet including multiple instructions, context information indicating an execution state of the instructions, and data to be processed by the instructions.

The packet interpreting unit 301 may transmit, to the packet transferring unit 304, a packet that is not a packet to be processed by the processing device 101. For example, the packet interpreting unit 301 determines whether the packet is a packet to be processed by the processing device 101 by using information included in the packet, such as a “destination”, an “identifier”, and the like.

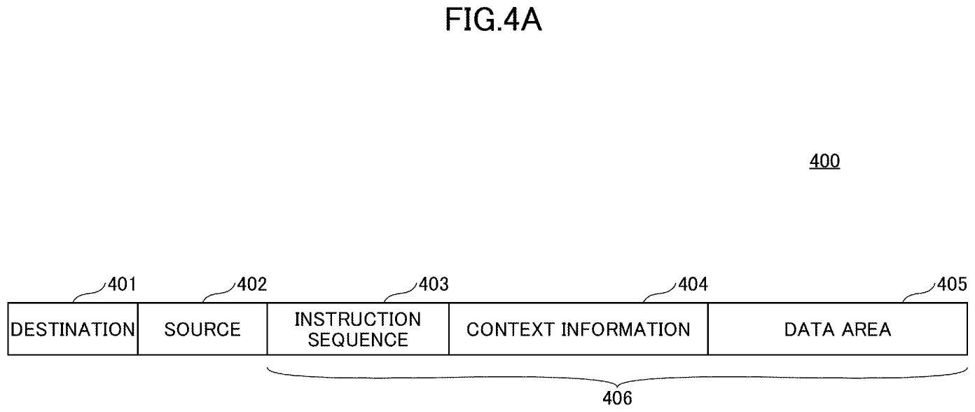

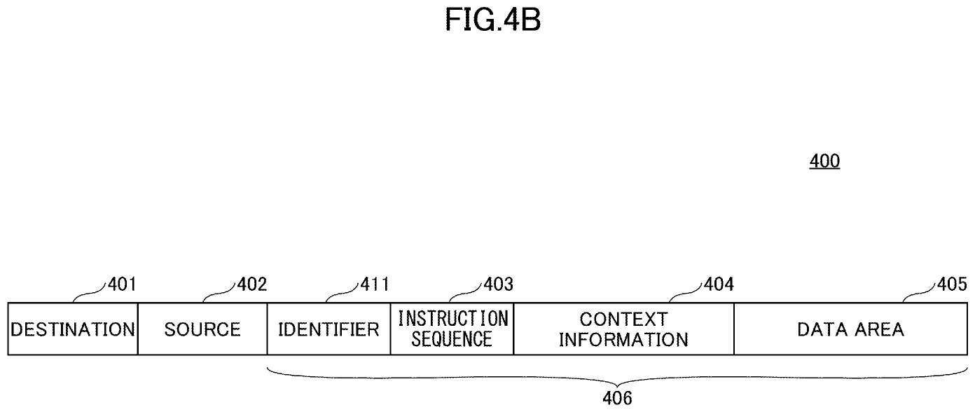

FIG. 4A and FIG. 4B are diagrams for explaining information included in the packet according to the first embodiment. FIG. 4A visually illustrates an example of the information included in the packet 400 according to the first embodiment. In the example of FIG. 4A, the packet 400 includes, for example, a destination 401, a source 402, an instruction sequence 403, context information 404, a data area 405, and the like.

The destination 401 may be information indicating a destination of the packet 400. For example, a destination internet protocol (IP) address or the like is used. The source 402 is information indicating a source of the packet 400. For example, a source IP address is used.

The instruction sequence 403 contains multiple instructions to be processed within the network NW. The multiple instructions include, for example, instructions that can be executed by the instruction executing unit 303, end of file (EOF) indicating completion of execution, and the like.

The context information 404 may store information (for example, an offset value) indicating an execution state of the multiple instructions stored in the instruction sequence 403. The data area 405 may store the data to be processed by the packet 400.

FIG. 4B visually illustrates another example of the information included in the packet 400 according to the first embodiment. In the example of FIG. 4B, the packet 400 may include information about an identifier 411 in addition to the information included in the packet 400 illustrated in FIG. 4A. The identifier 411 may be predetermined identification information indicating that the packet 400 is a packet to be processed by the processing device 101.

In FIG. 4A and FIG. 4B, the order in which each information is stored is an example. For example, the instruction sequence 403, the context information 404, and the data area 405 are stored in a payload 406 of the packet 400, but the order in which each information is stored may be different from the order in FIG. 4A and FIG. 4B.

In the example of FIG. 4B, if the packet 400 includes the identifier 411, the packet interpreting unit 301 can determine that the packet 400 is a packet to be processed by the processing device 101. If the packet 400 does not include the identifier 411, the packet interpreting unit 301 can determine that the packet 400 is not a packet to be processed by the processing device 101.

In the example of FIG. 4A, the packet interpreting unit 301 can determine whether the packet 400 is a packet to be processed by the processing device 101, by using, for example, the information about the destination 401.

For example, in the information processing system 100 illustrated in FIG. 1, the packet 400 is transmitted from the first terminal 102-1 to the second terminal 102-2. In this case, for example, multiple identifiers of a normal address, such as an IP address of a communication (hereinafter, referred to as a first address) and an address, such as an IP address for executing the process (hereinafter, referred to as a second address) are set in the second terminal 102-2 as the information about the destination 401. If the packet 400 illustrated in FIG. 4A is transmitted to the second terminal 102-2, the first terminal 102-1 sets the second address to the destination 401, and transmits the packet 400 to the network NW. Consequently, if the second address is set to the destination 401 of the packet 400, the packet interpreting unit 301 can determine that the packet 400 is a packet to be processed by the processing device 101. If the second address is not set to the destination 401 of the packet 400, the packet interpreting unit 301 can determine that the packet 400 is not a packet to be processed by the processing device 101. The destination 401 may be specified by a method by which the destination or the processing device can be set appropriately. As described above, an IP address may be used, and a MAC address or an MPLS label may be used.

Here, referring back to FIG. 3, the description of the functional configuration of the processing device 101 will be continued.

The instruction execution control unit 302 is, for example, implemented by a program executed by the CPU 201 of FIG. 2, and controls the execution of at least a part of the instructions stored in the instruction sequence 403 based on the context information 404 of the packet 400 received from the packet interpreting unit 301.

For example, the instruction execution control unit 302 extracts an instruction to be executed next that is indicated by an offset value included in the context information 404, passes the extracted instruction and data stored in the data area 405 to the instruction executing unit 303, and causes the instruction to be executed. If the instruction is executed by the instruction executing unit 303, the instruction execution control unit 302 updates the data area 405 by using a result of the execution of the instruction, and updates the offset value of the context information 404.

In this manner, the instruction execution control unit 302 may cause the instruction executing unit 303 to sequentially execute instructions that have not been executed among the multiple instructions stored in the instruction sequence 403 by using the context information 404 of the packet 400. The instruction execution control unit 302 may repeatedly perform this process until the offset value is EOF or until it is determined that the execution of the program should not continue.

Additionally, the instruction execution control unit 302 may determine whether the execution of the program should continue based on, for example, a usage state of resources and the elapsed time after the execution of the instruction is started. If the execution of the program should not continue, the instruction execution control unit 302 stops a process of causing the instruction executing unit 303 to execute the instructions sequentially.

For example, the instruction execution control unit 302 determines that the execution of the program should not continue if the usage rate of the CPU 201, the usage rate of the memory, or the like of the processing device 101 exceeds a threshold value. Alternatively, the instruction execution control unit 302 may determine that the execution of the program should not continue if the elapsed time after the execution of the instruction is started exceeds a threshold value. Further, the instruction execution control unit 302 may determine, by using other methods, that the execution of the program should not continue or that the program should be executed by another processing device.

The instruction executing unit 303 is implemented by, for example, the CPU 201, a program executed by the CPU 201 of FIG. 2, or the like, and the instruction executing unit 303 may execute the instruction in response to a control from the instruction execution control unit 302.

The packet transferring unit 304 is implemented by, for example, a program executed by the CPU of FIG. 2. The packet transferring unit 304 may transmit a packet received from the packet interpreting unit 301, a packet received from the instruction execution control unit 302, or the like to the processing device 101 or the terminal 102, which is a transfer destination, based on the pre-set routing table 305, a routing rule, or the like.

The routing table 305 is implemented by, for example, a program executed by the CPU 201 of FIG. 2 and a storage device 203, a memory 202, or the like, and a data transfer route determined by a predetermined routing algorithm or the like is stored. Here, according to the present embodiment, because a method of determining the data transfer route may be any method, the description about the method of determining the data transfer route is omitted.

The interface unit 306 is implemented by, for example, a program executed by the CPU 201 of FIG. 2 and a communication I/F 204, and the like, and transmits and receives packets to and from another processing device 101, the terminal 102, or the like.

The functional configuration of the processing device 101 illustrated in FIG. 3 is an example. For example, the function of the packet interpreting unit 301 may be provided by the packet transferring unit 304. Additionally, the function of the packet transferring unit 304 may be provided by the packet interpreting unit 301.

The instruction executing unit 303 may be included in the instruction execution control unit 302 or may be provided outside the processing device 101.

### Processing Flow

Next, a flow of a process performed by the processing device 101 according to the first embodiment will be described.

### Process of the Packet Interpreting Unit

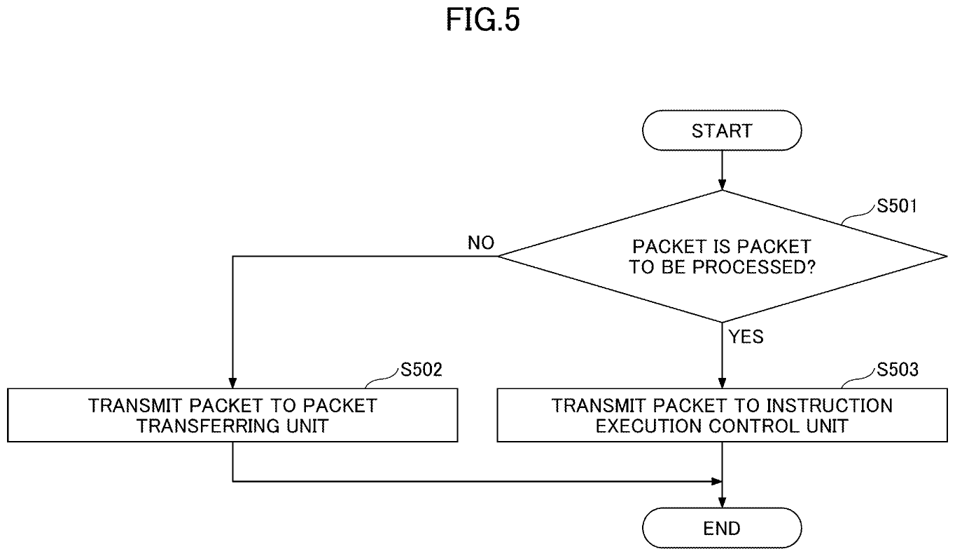

FIG. 5 is a flowchart illustrating an example of a process of a packet interpreting unit according to the first embodiment. The process indicates an example of a process performed by the packet interpreting unit 301 upon the interface unit 306 of the processing device 101 receiving the packet.

In step S501, the packet interpreting unit 301 may determine whether the packet received by the interface unit 306 is a packet to be processed by the processing device 101.

For example, the packet to be processed by the processing device 101 is a packet including the information as illustrated in FIG. 4A. In this case, if the above-described second address (for example, the IP address for the execution of the process) is set to the destination 401 of the received packet, the packet interpreting unit 301 determines that the received packet is a packet to be processed by the processing device 101. With respect to the above, if the above-described second address is not set to the destination 401 of the received packet, the packet interpreting unit 301 determines that the received packet is not a packet to be processed by the processing device 101.

As another example, the packet to be processed by the processing device 101 is a packet including the information as illustrated in FIG. 4B. In this case, if the above-described identifier 411 is included in the received packet, the packet interpreting unit 301 determines that the received packet is a packet to be processed by the processing device 101. With respect to the above, if the above-described identifier 411 is not included in the received packet, the packet interpreting unit 301 determines that the received packet is not a packet to be processed by the processing device 101.

If the received packet is not a packet to be processed by the processing device 101, the packet interpreting unit 301 moves the process to step S502. With respect to the above, if the received packet is a packet to be processed by the processing device 101, the packet interpreting unit 301 moves the process to step S503.

If the process proceeds to step S502, the packet interpreting unit 301 transmits the packet received by the interface unit 306 to the packet transferring unit 304. Consequently, the packet transferring unit 304 may transmit the packet to the transfer destination.

With respect to the above, if the process proceeds to step S503, the packet interpreting unit 301 transmits the packet 400, to be processed by the processing device 101, that is received by the interface unit 306 to the instruction execution control unit 302.

### Process of the Instruction Execution Control Unit

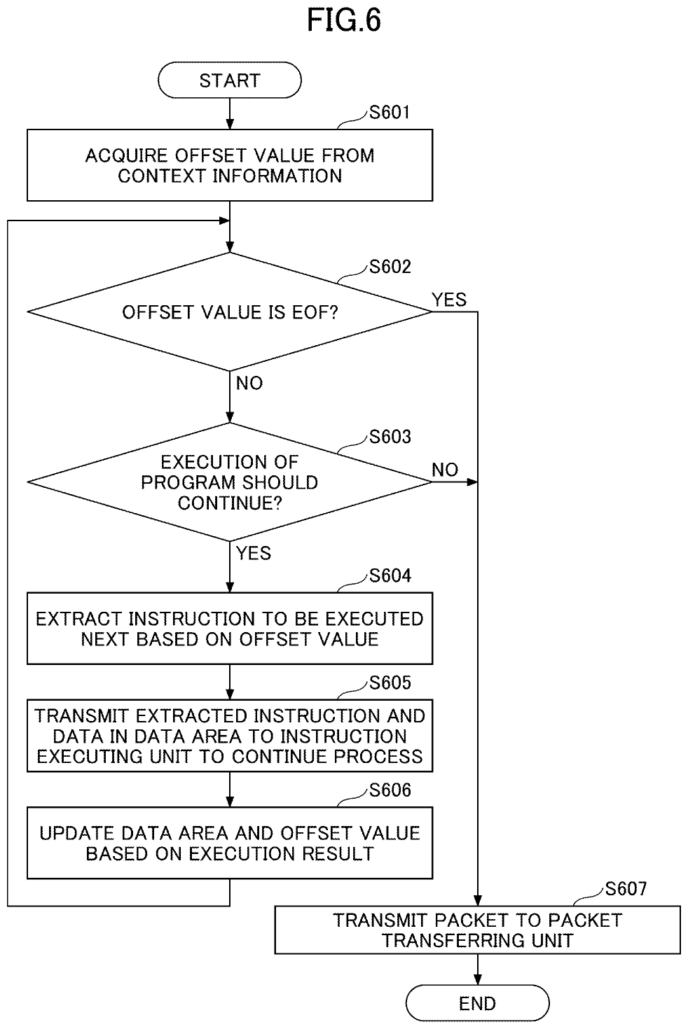

FIG. 6 is a flowchart illustrating an example of a process performed by the instruction execution control unit according to the first embodiment. The process indicates, for example, in step S503 of FIG. 5, an example of a process performed by the instruction execution control unit 302 when the packet interpreting unit 301 transmits the packet 400 to the instruction execution control unit 302.

In step S601, the instruction execution control unit 302 may acquire an offset value from the context information 404 of the packet 400 received from the packet interpreting unit 301.

In step S602, the instruction execution control unit 302 may determine whether the acquired offset value is EOF (i.e., a sign indicating a termination).

If the offset value is EOF, the instruction execution control unit 302 moves the process to step S607 and transmits the packet 400 to the packet transferring unit 304. Consequently, the packet transferring unit 304 may transmit the packet 400 to the transfer destination. Here, if at least a part of the multiple instructions included in the packet 400 is executed through the control of the instruction execution control unit 302, the packet 400 includes the context information 404 indicating that the instruction has been executed, data processed by the instruction, and the like.

With respect to the above, if the offset value is not EOF, the instruction execution control unit 302 moves the process to step 3603.

When the process proceeds to step S603, the instruction execution control unit 302 determines whether the execution of the program should continue. For example, the instruction execution control unit 302 may determine that the execution of the program should not continue if the usage rate of the CPU 201, the usage rate of the memory, or the like of the processing device 101 exceeds a threshold value. Alternatively, the instruction execution control unit 302 may determine that the execution of the program should not continue if the elapsed time after the execution of the instruction is started exceeds a threshold value.

With such a process, the instruction execution control unit 302 may preferably determine that execution of the program should not continue if the load of the processing device 101 is heavy and there is a possibility that the device itself may become a bottleneck of the processing. However, the instruction execution control unit 302 may determine whether the execution of the program should continue by another method.

If it is determined that the execution of the program should not continue, the instruction execution control unit 302 moves the process to step S607. With respect to the above, if it is determined that the execution of the program should continue, the instruction execution control unit 302 moves the process to step S604.

If the process proceeds to step S604, the instruction execution control unit 302 extracts an instruction to be executed next based on the offset value. For example, the instruction execution control unit 302 extracts an instruction corresponding to the offset value from the multiple instructions stored in the instruction sequence 403 of the packet 400.

In step S605, the instruction execution control unit 302 may transmit the extracted instruction and the data in the data area 405 to the instruction executing unit 303 and causes the instruction executing unit 303 to execute the instruction.

In step S606, the instruction execution control unit 302 updates the data area 405 of the packet 400 and the offset value of the context information 404 based on a result of the execution by the instruction executing unit 303 and the process returns to step S602. For example, the instruction execution control unit 302 increments the offset value of the context information 404 and stores the result of the execution by the instruction executing unit 303 in the data area 405.

With the above-described process, the instruction execution control unit 302 may cause the instruction executing unit 303 to sequentially execute instructions that have not been executed among the multiple instructions stored in the instruction sequence 403 until the offset value becomes EOF or until it is determined that the execution of the program should not continue.

### Example of an Operation of the Information Processing System

Next, an operation of an information processing method performed by the information processing system 100 according to the first embodiment will be described with reference to a specific example.

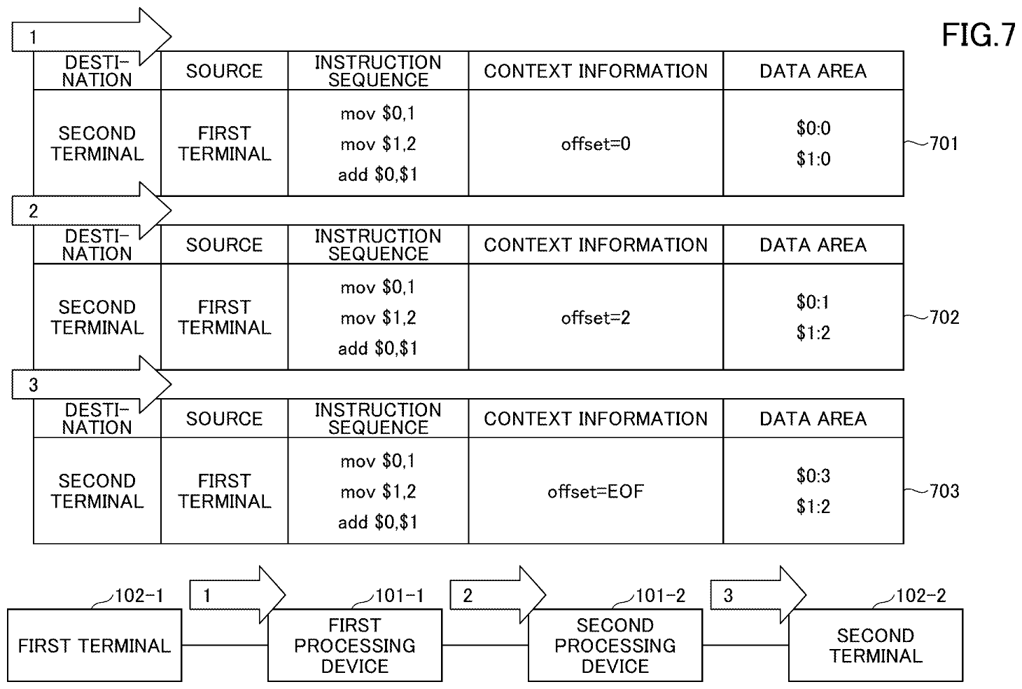

FIG. 7 is a diagram for explaining an example of the operation of the information processing system according to the first embodiment. The following instructions will be used here as an example for explanation.

The instruction “mov $0, 1” is assumed to be an instruction to copy the data “1” to “$0”, which is an address “0” of the data area. Additionally, the instruction “mov $1, 2” is assumed to be an instruction to copy the data “2” to “$1”, which is an address “1” of the data area. Further, the instruction “add $0, $1” is assumed to be an instruction to add data of “$0” and data of “$1” and store a result of the addition in “$0”.

In FIG. 7, the first terminal 102-1 transmits a packet 701 to the first processing device 101-1.

In response to the packet interpreting unit 301 of the first processing device 101-1 receiving the packet 701, the packet interpreting unit 301 may determine that the packet 701 is a packet to be processed, and transmits the packet 701 to the instruction execution control unit 302.

The instruction execution control unit 302 of the first processing device 101-1 may acquire an offset value “0” from the context information of the packet 701 and may cause the instruction executing unit 303 to execute “mov $0, 1”, which is a first instruction (i.e., an instruction corresponding to the offset value “0”). With this execution, the data “1” may be copied to the data area “$0”, and the offset value of the context information may be incremented to “1”.

Subsequently, the instruction execution control unit 302 of the first processing device 101-1 may acquire the offset value “1” from the context information of the packet 701 and causes the instruction executing unit 303 to execute “mov $1, 2”, which may be a next instruction (i.e., an instruction corresponding to the offset value “1”). With this execution, the data “2” may be copied to the data area “$1”, and the offset value of the context information may be incremented to “2”.

Here, as an example for explanation, it is assumed that the instruction execution control unit 302 of the first processing device 101-1, for example, determines that the load of the processing device 101 is heavy and the execution of the program should not continue. This may cause the packet transferring unit 304 of the first processing device 101-1 to transmit the packet 702 to the transfer destination (here, the second processing device 101-2).

In the context information of the packet 702, the offset value may be updated to “2” because two instructions have been executed by the first processing device 101-1. Additionally, the data “1” is copied to the data area “$1” by the first instruction, and the data “2” is copied to the data area “$2” by the second instruction.

In response to the packet interpreting unit 301 of the second processing device 101-2 receiving the packet 702, the packet interpreting unit 301 may determine that the packet 702 is a packet to be processed, and transmits the packet 702 to the instruction execution control unit 302.

The instruction execution control unit 302 of the second processing device 101-2 may acquire the offset value “2” from the context information of the packet 702 and may cause the instruction executing unit 303 to execute “add $0, $1”, which is a third instruction (i.e., an instruction corresponding to the offset value “2”). With this execution, the data “3”, which is obtained by adding the data “1” of the data area “$0” and the data “2” of the data area “$1”, may be stored in the data area “$0”. Consequently, all instructions have been executed, and thus EOF may be set as the offset value of the context information.

As described, the packet transferring unit 304 of the first processing device 101-1 may transmit the packet 703 to the transfer destination (here, the second terminal 102-2).

As described, in the information processing system 100 according to the present embodiment, when the packet is transmitted from the first terminal 102-1 to the second terminal 102-2 via the network NW, any process can be executed by using the multiple processing devices 101 during the transmission of the packet.

Additionally, for example, if the load of a given processing device 101 is heavy, the given processing device 101 can transmit a packet including the execution state of multiple instructions, the data being processed, and the like to another processing device 101 that is the transfer destination even in the middle of the processing, and another processing device 101 can take over the processing. Therefore, the load can be distributed among the multiple processing devices 101.

### Second Embodiment

In a second embodiment, an example in which a program executed in the network NW can utilize a memory provided by the processing device 101 (hereinafter, referred to as a device memory) will be described.

### Functional Configuration

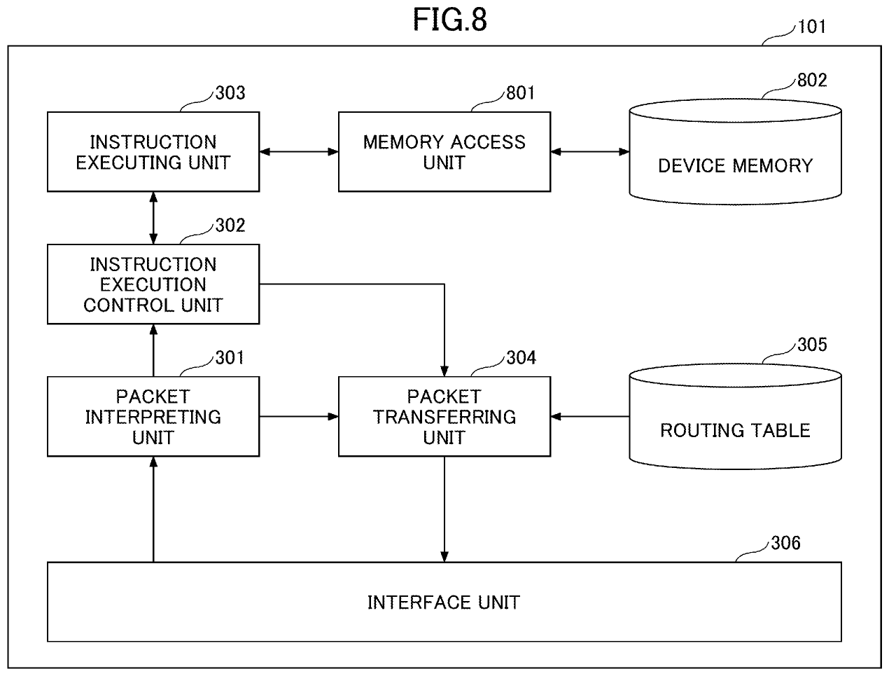

FIG. 8 is a diagram illustrating an example of a functional configuration of a processing device according to the second embodiment. As illustrated in FIG. 8, the processing device 101 according to the second embodiment may include a memory access unit 801, a device memory 802, and the like in addition to the functional configuration of the processing device 101 according to the first embodiment illustrated in FIG. 3.

The memory access unit 801 is implemented by, for example, a program executed by the CPU 201 of FIG. 2, and manages a storage area of the device memory 802 for each identification information (hereinafter, referred to as an application ID) that identifies a program to be processed in the network NW.

The device memory 802 may be a memory (i.e., a storage device) provided by the processing device 101 and is implemented by, for example, the memory 202, the storage device 203, or the like of FIG. 2.

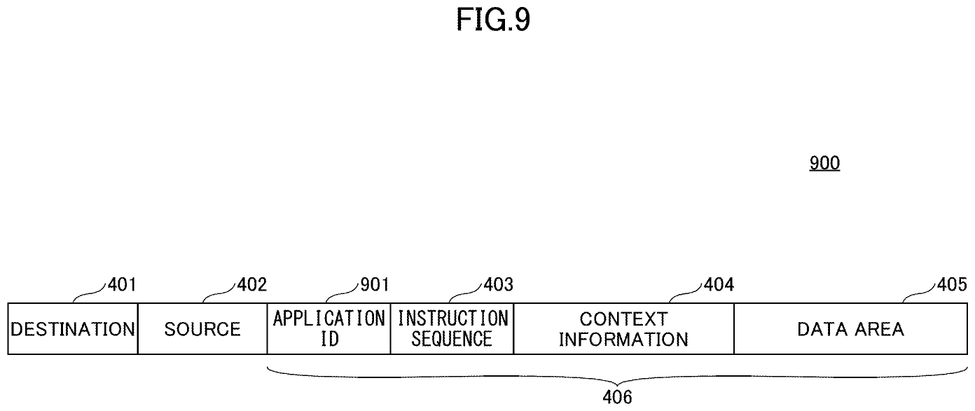

FIG. 9 is a diagram illustrating an example of a configuration of a packet according to the second embodiment. As illustrated in FIG. 9, the packet 900 according to the second embodiment includes, for example, an application ID 901 in addition to the information included in the packet 400 according to the first embodiment illustrated in FIG. 4A.

In the second embodiment, multiple instructions stored in the instruction sequence 403 may include an instruction that accesses the device memory 802. In response to receiving an instruction to access the device memory 802, the memory access unit 801 accesses a storage area different for each of the application IDs 901.

### Processing Flow

### Process of the Instruction Execution Conrol Unit

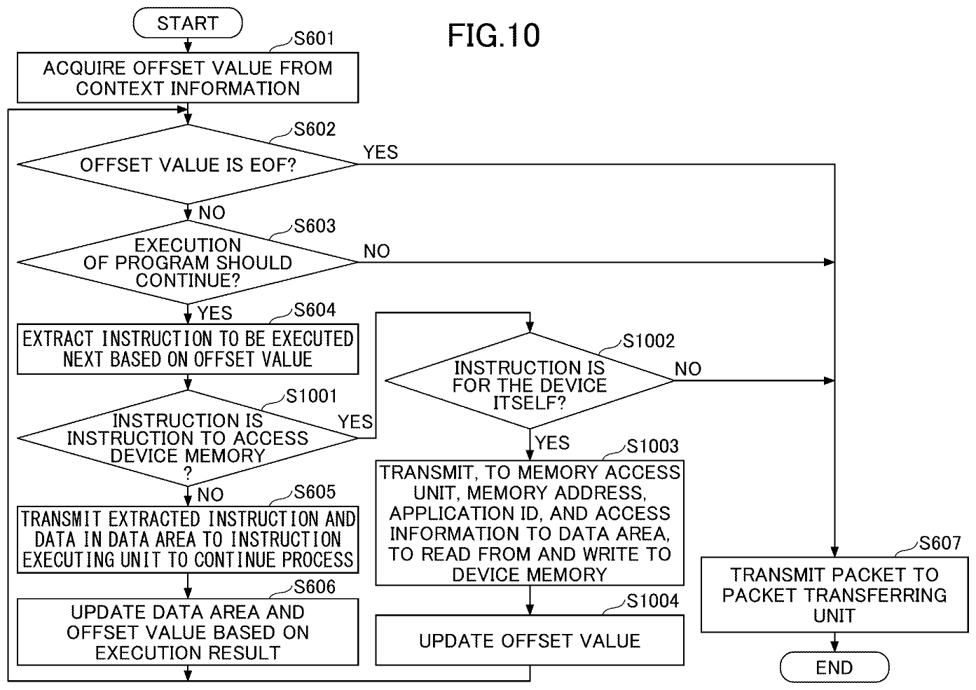

FIG. 10 is a flowchart illustrating an example of a process of the instruction execution control unit according to the second embodiment. Among the processing illustrated in FIG. 10, the processing of steps S601 to S607 are substantially the same as the processing according to the first embodiment illustrated in FIG. 6. Therefore, points different from the the first embodiment will be mainly described here.

In step S1001, the instruction execution control unit 302 of the processing device 101 determines whether the instruction extracted in step S604 is an access instruction to access the device memory 802. If the extracted instruction is not the access instruction to access the device memory 802, the instruction execution control unit 302 moves the process to step S605. With respect to the above, if the extracted instruction is the access instruction to access the device memory 802, the instruction execution control unit 302 moves the process to step S1002.

When the process proceeds to step S1002, the instruction execution control unit 302 determines whether the access instruction is an instruction for the device itself. If the access instruction is not an instruction for the device itself, for example, if the access instruction is an instruction for another processing device 101, the instruction execution control unit 302 moves the process to step S607. With respect to the above, if the access instruction is an instruction for the device itself, the instruction execution control unit 302 moves the process to step S1003.

When the process proceeds to step S1003, the instruction execution control unit 302 transmits, to the memory access unit 801, a memory address, the application ID, and access information to the data area, and causes the memory access unit 801 to access the device memory 802 (writing or reading of data).

In step S1004, the instruction execution control unit 302 updates (for example, increments) the offset value and returns the process to step S602.

With the above-described process, the instruction execution control unit 302 can access the device memory 802 by using the memory access unit 801 if the instruction to be executed is an access instruction to access the device memory 802 of the device itself (i.e., the processing device 101).

### Process of the Memory Access Unit

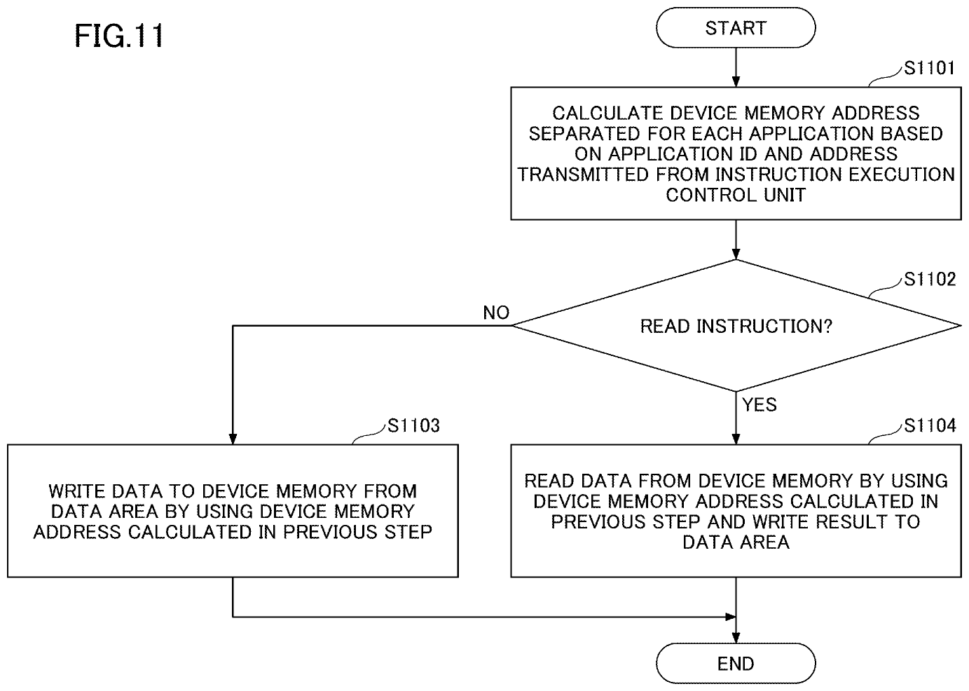

FIG. 11 is a flowchart illustrating an example of a process of the memory access unit according to the second embodiment. The process indicates, for example, in step S1003 of FIG. 10, an example of the process executed when the memory access unit 801 is instructed to access the device memory 802 from the instruction execution control unit 302.

In step S1101, the memory access unit 801 of the processing device 101 may calculate a device memory address separated for each program (i.e., each application) based on the application ID and the address transmitted from the instruction execution control unit 302.

In step S1102, the memory access unit 801 may determine whether the instruction transmitted from the instruction execution control unit 302 is a read instruction or a write instruction. If the instruction is a write instruction, the memory access unit 801 moves the process to step S1103. If the instruction is a read instruction, the memory access unit 801 moves the process to step S1104.

When the process proceeds to step S1103, the memory access unit 801 writes data of the data area 405 to the device memory 802 by using the device memory address calculated in step S1101.

When the process proceeds to step S1104, the memory access unit 801 reads data from the device memory address calculated in step S1101 and writes the read data in the data area 405.

### Example of an Operation of the Information Processing System

Next, an operation of an information processing method performed by the information processing system 100 according to the second embodiment will be described with reference to a specific example.

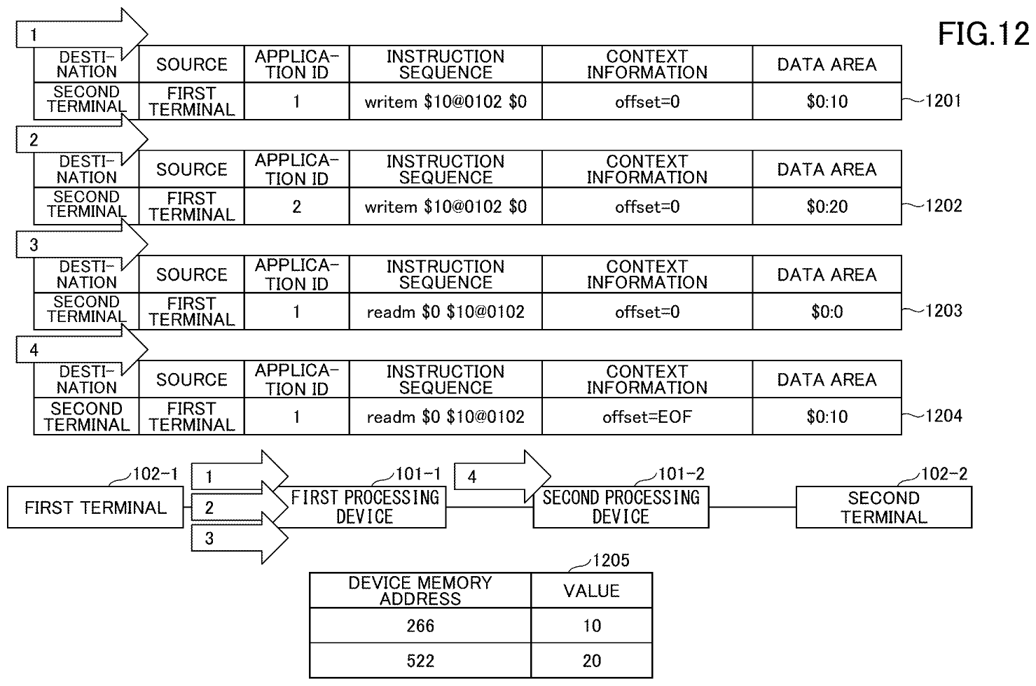

FIG. 12 is a diagram for explaining an example of the operation of the information processing system according to the second embodiment. Here, the following instructions are used as an example for explanation.

It is assumed that the instruction “writem $10@0102 $0” is an instruction to write data at “$0” representing an address “0” of the data area to “$10@102” indicating an address “10” of the device memory “0102”. It is assumed that the device memory “0102” represents the device memory 802 provided by the first processing device 101-1.

It is assumed that the instruction “readm $0 $10@0102” is an instruction to read data from “$10@0102” representing an address “10” of the device memory “0102” to “$0” representing an address “0” of the data area.

In FIG. 12, the first terminal 102-1 may transmit the packet 1201 to the first processing device 101-1.

In response to the packet interpreting unit 301 of the first processing device 101-1 receiving the packet 1201, the packet interpreting unit 301 may determine that the packet 1201 is a packet to be processed, and transmits the packet 1201 to the instruction execution control unit 302.

The instruction execution control unit 302 of the first processing device 101-1 may acquire the offset value “0” from the context information of the packet 1201 and may control the execution of a first instruction “writem $10@0102 $0” (i.e., an instruction corresponding to the offset value “0”). Here, the instruction to be executed is a write instruction to the device memory “0102”, and thus the instruction execution control unit 302 may transmit an application ID “1”, information “$10@102” that specifies the device memory 802 and an address, and data “10” (or information for obtaining data) to the memory access unit 801.

Consequently, the memory access unit 801 may calculate the device memory address (for example, the device memory address “266” of the table 1205) separated for each application based on the application ID “1” and the information “$10@102” that specifies the device memory 802 and the address. Additionally, the memory access unit 801 may write the data “10” to the calculated device memory address “266” as illustrated in the table 1205, for example.

Subsequently, the first terminal 102-1 may transmit the packet 1202 to the first processing device 101-1.

In response to the packet interpreting unit 301 of the first processing device 101-1 receiving the packet 1202, the packet interpreting unit 301 may determine that the packet 1202 is a packet to be processed, and transmits the packet 1202 to the instruction execution control unit 302.

The instruction execution control unit 302 of the first processing device 101-1 may acquire the offset value “0” from the context information of the packet 1202 and may control the execution of the first instruction (i.e., the instruction corresponding to the offset value “0”). Here, the instruction to be executed is a write instruction to the device memory “0102”, and thus the instruction execution control unit 302 may transmit, to the memory access unit 801, an application ID “2”, information “$10@102” that specifies the device memory 802 and the address, and data “20” (or information for obtaining data).

Consequently, the memory access unit 801 may calculate the device memory address (for example, the device memory address “522” of the table 1205) separated for each application based on the application ID “2” and the information “$10@102” that specifies the device memory 802 and the address. The memory access unit 801 may write data “20” to the calculated device memory address “522” as illustrated in the table 1205.

As described, according to the present embodiment, when data is written from different applications to the same address of the same device memory 802, the data is written to different storage areas, so that a conflict of writing between applications can be avoided.

Subsequently, the first terminal 102-1 may transmit the packet 1203 to the first processing device 101-1.

In response to the packet interpreting unit 301 of the first processing device 101-1 receiving the packet 1203, the packet interpreting unit 301 may determine that the packet 1203 is a packet to be processed, and may transmit the packet 1203 to the instruction execution control unit 302.

The instruction execution control unit 302 of the first processing device 101-1 may acquire the offset value “0” from the context information of the packet 1203 and controls the execution of the first instruction (i.e., the instruction corresponding to the offset value “0”). Here, the instruction to be executed may be a read instruction to the device memory “0102”, and thus the instruction execution control unit 302 may transmit, to the memory access unit 801, the application ID “1”, information“$10@102” that specifies the device memory 802 and the address, and the like.

Consequently, the memory access unit 801 may calculate a device memory address (here, a memory address “266”) separated for each application based on the application ID “1” and the information “$10@102” that specifies the device memory 802 and the address. Additionally, the memory access unit 801 may read the data “10” stored in the calculated device memory address “266” as illustrated in the table 1205.

This may update the packet 1203 of FIG. 12 as illustrated in the packet 1204. For example, the offset value included in the context information is updated from “0” to “EOF”, and the data “$0:0” in the data area is updated to “$0:10”.

The instruction execution control unit 302 may transmit, to the packet transferring unit 304, the packet 1204 in which the offset value is “EOF”.

In response to this, the packet transferring unit 304 may transmit the packet 1204 to the transfer destination (for example, the second processing device 101-2).

As a result of the above-described process, the memory access unit 801 can manage the storage area of the device memory 802 for each application ID (for each program). This may allow the processing device 101 to utilize the device memory 802 in the processing device 101 through instructions included in the instruction sequence 403 of the packet 900 without causing conflicts between multiple applications (programs).

Thus, for example, an application that counts the number of times of data passing for each application on each processing device 101 can be achieved without causing conflicts between applications.

As described above, according to the embodiments of the present disclosure, in the information processing system 100 including multiple processing devices 101 that execute predetermined processing while a packet is being transferred in the network NW, a given program can be specified from the terminal 102 to execute the process.

As the processing device 101 stores the context information and the data to be processed in the packet and transmits the packet to another processing device 101, another processing device 101 can take over the processing even in the middle of the processing.

According to the second embodiment, the device memory 802 provided by the processing device 101 can be accessed without conflicts among multiple programs. This can easily achieve, for example, processing such as aggregating data from the multiple terminals 102.

Here, the instructions illustrated in the above-described embodiments are examples for explaining, and the processing device 101 according to the present embodiment may execute various instructions specified from the terminal 102. For example, the instructions executed by the processing device 101 may include an aggregate instruction that performs data aggregation. If the instruction to be executed is an aggregate instruction, the processing device 101 may wait for data from another terminal 102 and aggregate the data when the data arrives.

This enables, for example, in FIG. 1, the first terminal 102-1 to transmit a part of processing to the first processing device 101-1, and transmit a remaining processing to the third processing device 101-3. The second processing device 101-2 aggregates the data, and transmits the data to the second terminal 102-2.

What is claimed is:

1. A processing device comprising:
at least one memory; and
at least one processor configured to:
receive a packet including a plurality of instructions, context information indicating an execution state of the plurality of instructions, and data to be processed by the plurality of instructions;
execute at least a part of the plurality of instructions based on the context information; and
transmit the packet to another processing device, after executing the at least the part of the plurality of instructions by the processing device, to cause at least a part of remaining instructions among the plurality of instructions to be executed, based on the context information, the remaining instructions being not executed by the processing device.

2. The processing device as claimed in claim 1, wherein the packet transmitted to the another processing device includes the processed data.

3. The processing device as claimed in claim 1, wherein the at least one processor stops executing the at least the part of the plurality of instructions based on a resource usage state of the processing device.

4. The processing device as claimed in claim 1, wherein the at least one processor stops executing the at least the part of the plurality of instructions based on an elapsed time duration from a start of the execution of the at least the part of the plurality of instructions.

5. The processing device as claimed in claim 1, wherein a value of the context information increases as the at least the part of the plurality of instructions are executed.

6. The processing device as claimed in claim 1, wherein a storage area of the at least one memory is reserved for each program, the packet includes identification information, and the identification information identifies the program to be processed.

7. The processing device as claimed in claim 1, wherein the packet includes identifier, and the packet is processed by the first processing device in accordance with the identifier.

8. A processing method comprising:
receiving, by a processing device, a packet including a plurality of instructions, context information indicating an execution state of the plurality of instructions, and data to be processed by the plurality of instructions;
executing, by the processing device, at least a part of the plurality of instructions based on the context information; and
transmitting, by the processing device, the packet to another processing device, after executing the at least the part of the plurality of instructions by the processing device, to cause at least a part of remaining instructions among the plurality of instructions to be executed, based on the context information, the remaining instructions being not executed by the processing device.

9. The processing method as claimed in claim 8, wherein the packet transmitted to the another processing device includes the processed data.

10. The processing method as claimed in claim 8, further comprising:
stopping, by the processing device, executing the at least the part of the plurality of instructions based on a resource usage state of the processing device.

11. The processing method as claimed in claim 8, further comprising:
stopping, by the processing device, executing the at least the part of the plurality of instructions based on an elapsed time duration from a start of the execution of the at least the part of the plurality of instructions.

12. The processing method as claimed in claim 8, wherein a value of the context information increases as the at least the part of the plurality of instructions are executed.

13. The processing method as claimed in claim 8, wherein a storage area of at least one memory is reserved for each program, the packet includes identification information, and the identification information identifies the program to be processed.

14. The processing method as claimed in claim 8, wherein the packet includes identifier, and the packet is processed by the first processing device in accordance with the identifier.

15. A processing system comprising:
a first processing device having at least one first memory and at least one first processor; and
a second processing device having at least one second memory and at least one second processor;
the at least one first processor of the first processing device is configured to:
receive a packet including a plurality of instructions, context information indicating an execution state of the plurality of instructions, and data to be processed by the plurality of instructions;
execute at least a part of the plurality of instructions based on the context information; and
transmit the packet to the second processing device, after executing the at least the part of the plurality of instructions by the first processing device, and
the at least one second processor of the second processing device is configured to:
execute at least a part of remaining instructions among the plurality of instructions, based on the context information, the remaining instructions being not executed by the first processing device.

16. The processing system as claimed in claim 15, wherein the packet transmitted to the second processing device includes the processed data.

17. The processing system as claimed in claim 15, wherein the at least one first processor stops executing the at least the part of the plurality of instructions based on a resource usage state of the first processing device.

18. The processing system as claimed in claim 15, wherein the at least one first processor stops executing the at least the part of the plurality of instructions based on an elapsed time duration from a start of the execution of the at least the part of the plurality of instructions.

19. The processing system as claimed in claim 15, wherein a value of the context information increases as the at least the part of the plurality of instructions are executed.

20. The processing system as claimed in claim 15, wherein a storage area of the at least one first memory is reserved for each program, the packet includes identification information, and the identification information identifies the program to be processed.
